(19) United States
(12) Patent Application Publication
(10) Pub. No.: US 2026/0208804 A1
(43) Pub. Date: Jul. 23, 2026

(54) WALK-BEHIND APPARATUS WITH CONTINUOUS TRACKS

(71) Applicant: Barreto Manufacturing, Inc., La Grande, OR (US)

(72) Inventors: Gregory L. Barreto, Coffman Cove, AK (US); Stephen Barreto, Boise, ID (US); Lucas T. Barreto, Boise, ID (US)

(73) Assignee: Barreto Manufacturing, Inc., La Grande, OR (US)

(21) Appl. No.: 19/454,127

(22) Filed: Jan. 20, 2026

Related U.S. Application Data
(60) Provisional application No. 63/747,845, filed on Jan. 21, 2025.

(51) Int. Cl. B62D 55/30; B60K 8/00; B62D 55/14; F15B 15/18

(52) U.S. Cl. CPC B62D 55/305; B60K 8/00; B62D 55/14; F15B 15/18

(57) ABSTRACT

A walk-behind apparatus can include a carriage assembly and one or more continuous track drive systems made up of one or more drive wheels and/or idler wheels, a continuous track, and a tensioning system. The tensioning system can include a biasing member, a tension rod, and a pivot joint. The tensioning system can be configured such that when the pivot joint pivots outward away from the carriage assembly to a first state and inward toward the carriage assembly to a second state and there is more tension on the continuous track in the second state than in the first state.

### CROSS REFERENCE TO RELATED APPLICATION

This application claims the benefit of U.S. Provisional Patent Application No. 63/747,845, filed January 21, 2025, which is incorporated herein by reference.

### FIELD

The present disclosure concerns examples of apparatuses with track drives and tensioning systems for improved traction and steerability. In particular walk-behind apparatuses for cutting sod which have track drives and tensioning systems.

### BACKGROUND

Walk-behind apparatus, such as lawnmowers, snow blowers, and/or sod cutters often employ wheels for traction and steering. These wheels can make it easier for the user to translate the apparatus along the ground as they are used. These wheels can also slip and/or fail to get enough traction to drive themselves along.

To improve the traction, a number of walk-behind apparatus employ a pair of continuous tracks for propulsion. These walk-behind machines can include carriages with a drive wheel or sprocket that propels the continuous track as well as longitudinally spaced fore and aft idlers such as idler wheels, with a plurality of rollers or roller wheels distributed between the idlers for load bearing support and terrain adaptability.

### SUMMARY

Described herein is a walk-behind apparatus with a continuous track and method of use. The disclosed walk-behind apparatus can, for example, provide better traction and steering. The walk-behind apparatus can also allow easier removal of the continuous track. As such, the walk-behind apparatus and methods of use disclosed herein can, among other things, overcome one or more of the deficiencies of typical walk-behind apparatuses.

In some examples, a walk-behind apparatus comprises: a carriage assembly; a hydrostatic pump; and two drive assemblies, each drive assembly comprising: a hydraulic motor, hydraulicly coupled to the hydrostatic pump; a pivotable idler wheel pivotably coupled to the carriage assembly at a pivot point, wherein the pivot point is fixed relative to the carriage assembly; a fixed idler wheel rotatably coupled to the carriage assembly; a drive wheel rotatably coupled to the carriage assembly; a continuous track extending around the pivotable idler wheel, the fixed idler wheel, and the drive wheel; and a tensioning system comprising: a tensioner rod with a first end portion and a second end portion, wherein the first end portion is coupled to the pivotable idler wheel; and a lever member pivotably coupled to the carriage assembly and to the second end portion of the tensioner rod, wherein pivoting the lever member outward away from the carriage assembly results in the pivotable idler wheel moving in a first direction relative to the carriage assembly and reducing tension in the continuous track, and wherein pivoting the lever member inward toward the carriage assembly results in the pivotable idler wheel moving in a second direction relative to the carriage assembly and increases tension in the continuous track.

In some examples, the walk-behind apparatus further comprises a biasing member disposed around the tensioner rod, wherein the biasing member is sized and shaped to maintain tension in the continuous track while the lever member is pivoted inward toward the carriage assembly. In some examples, the walk-behind apparatus further comprising an adjustment member disposed on the tensioner rod, wherein adjusting a position of the adjustment member results in a change in compression of the biasing member.

In some examples, the lever member comprises a first plate and a second plate. In some examples, the drive wheel is driven by the hydraulic motor. In some examples, a heim joint couples the lever member to the second end portion of the tensioner rod.

In some examples, a walk-behind apparatus comprises: a carriage assembly; and one or more drive assemblies, each drive assembly comprising: a pivotable idler wheel pivotably coupled to the carriage assembly at a pivot point wherein the pivot point is fixed relative to the carriage assembly; a drive wheel; a continuous track extending around the pivotable idler wheel and the drive wheel; and a tensioning system comprising: a tensioner rod with a first end portion and a second end portion, wherein the second end portion is coupled to the pivotable idler wheel; and a lever member pivotably coupled to the carriage assembly and pivotably coupled to the first end portion of the tensioner rod, wherein the lever member pivots outward away from the carriage assembly to a first state and inward toward the carriage assembly to a second state to move the pivotable idler wheel from a first position to a second position, and wherein there is more tension on the continuous track in the second state than in the first state.

In some examples, each drive assembly further comprising a fixed idler wheel rotatably coupled to the carriage assembly, wherein the continuous track extends around the fixed idler wheel. In some examples, a biasing member is disposed around the tensioner rod, wherein the biasing member is sized and shaped to maintain tension in the continuous track while the pivot joint is in the second state. In some examples, the biasing member is a coil spring. In some examples, the walk-behind apparatus further comprises an adjustment member wherein adjusting the adjustment member results in the biasing member transitioning from a first compression to a second compression.

In some examples, the lever member comprises a first plate and a second plate. In some examples, a heim joint couples the lever member to the first end portion of the tensioner rod. In some examples, the drive wheel is driven by a hydraulic motor. In some examples, the hydraulic motor is hydraulically coupled to a hydrostatic pump. In some examples, the hydraulic motor is hydraulically coupled to the hydrostatic pump without a hydraulic differential.

In some examples, a method of operating the walk-behind apparatus comprises: tensioning the continuous track by moving the lever member from the first state to the second state. In some examples, the apparatus further comprises a biasing member disposed around the tensioner rod and an adjustment member, and the method further comprises adjusting a position of the adjustment member to change the compression in the biasing member.

In some examples, a track drive assembly comprises: a pivotable idler wheel pivotable relative to a fixed pivot point; a drive wheel driven by a hydraulic motor; a continuous track extending around the pivotable idler wheel and the drive wheel; and a tensioning system comprising: a tensioner rod with a first end portion and a second end portion wherein the second end portion is coupled to the pivotable idler wheel; and a lever member pivotably coupled between a carriage assembly and the first end portion of the tensioner rod, wherein the lever member pivots outward away from the carriage assembly to a first state and inward toward the carriage assembly to a second state, and wherein there is more tension on the continuous track in the second state than in the first state.

In some examples, the track drive assembly further comprises a fixed idler wheel rotatably coupled to the carriage assembly, wherein the continuous track extends around the fixed idler wheel.

The foregoing and other objects, features, and advantages of the invention will become more apparent from the following detailed description, which proceeds with reference to the accompanying figures.

### BRIEF DESCRIPTION OF THE DRAWINGS

FIGS. 1A-1C depict views of a sod cutter according to one example.

FIGS. 2A-2B depict portions of a drive assembly of the sod cutter of FIG. 1 with the continuous track removed.

FIG. 3 depicts an exploded view of the tensioning system of the sod cutter of FIG. 1 with the continuous track removed.

FIGS. 4A-4B depict portions of a drive assembly of the sod cutter of FIG. 1 with the continuous track removed and the tensioning system in a position corresponding to reduced tension in the continuous track.

FIGS. 5A-5B depict portions of a drive assembly of the sod cutter of FIG. 1 with the continuous track removed and the tensioning system in a position corresponding to increased tension in the continuous track.

FIG. 6 depicts a schematic of a hydraulic system of the sod cutter of FIG. 1.

FIGS. 7A-7D depict the sod cutter of FIG. 1 with hydraulic hoses installed according to the hydraulic schematic shown in FIG. 6

### DETAILED DESCRIPTION

Described herein are examples of walk-behind apparatus with continuous track drive systems that employ a tensioning system to maintain tension in the track when the track is moving. While the apparatus described herein is self-propelled, the term “walk-behind apparatus” can include push behind apparatus and/or self-propelled apparatus, and the track drive systems described herein can also be applicable to machines that are not self-propelled. The tensioning system can employ a biasing member, a tensioner rod, and a pivot joint. The pivot joint can be coupled on one end to the tensioner rod and on the other end to a carriage assembly and can pivot outward away from the carriage assembly to reduce tension in the continuous track and inward toward the carriage assembly to increase tension in the continuous track. In addition to the tensioning system, the disclosed carriage assemblies can also have a pivotable idler wheel, a drive wheel, and one or more fixed idler wheels for operation of a continuous track drive system.

The walk-behind apparatus can employ a pair of continuous track systems for propulsion. The continuous track systems can include carriages with a drive wheel or sprocket that propels the continuous track as well as longitudinally spaced fore and aft idlers such as idler wheels, with a plurality of rollers or roller wheels distributed between the idlers for load bearing support and terrain adaptability. In a typical arrangement, a pivotable idler wheel tensions the track during forward motion. The walk-behind apparatus described herein can include an engine and can have one or more continuous track systems and a hydraulic system that is powered by the engine. Although the apparatus described herein is configured for cutting sod, the continuous track systems described herein can be used on any of a variety of walk-behind apparatus such as those for use in the construction and landscaping industries.

The disclosed technology can be applicable to any vehicle having a continuous track propulsion system, including utility vehicles such as walk-behind vehicles and riding vehicles (e.g., sod cutters, trenchers, chippers, mulchers, shredders, lawn mowers, snowmobiles, etc.), construction vehicles (e.g., bulldozers, excavators, skid-steer loaders, etc.), military vehicles, or the like. Although the disclosed technology may also be applied in analogous manner to vehicles with other types of multi-wheel traction systems, the proceeding description is with reference to an exemplary tracked walk-behind apparatus as a non-limiting example in order to conveniently illustrate the details of the disclosed technology.

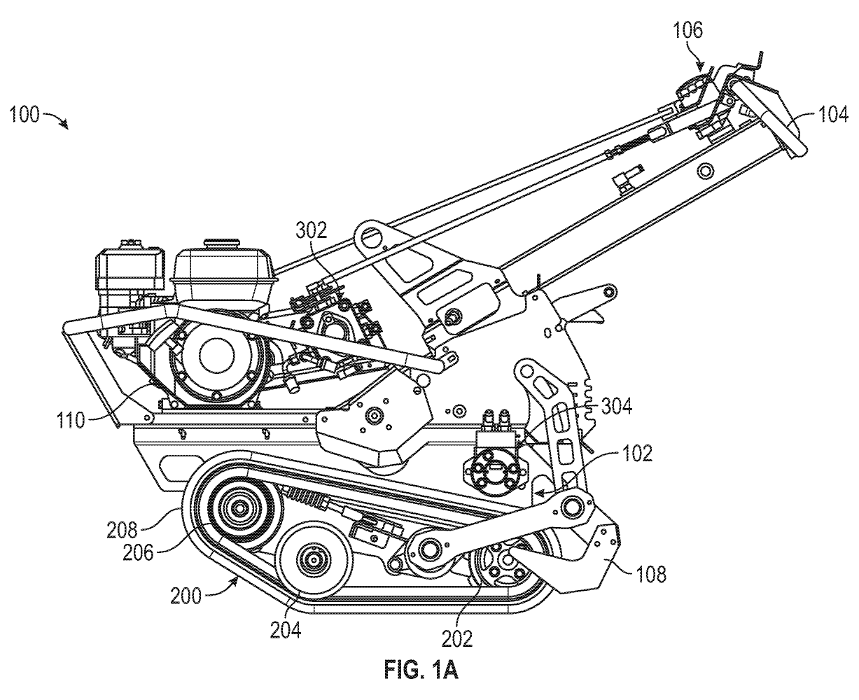

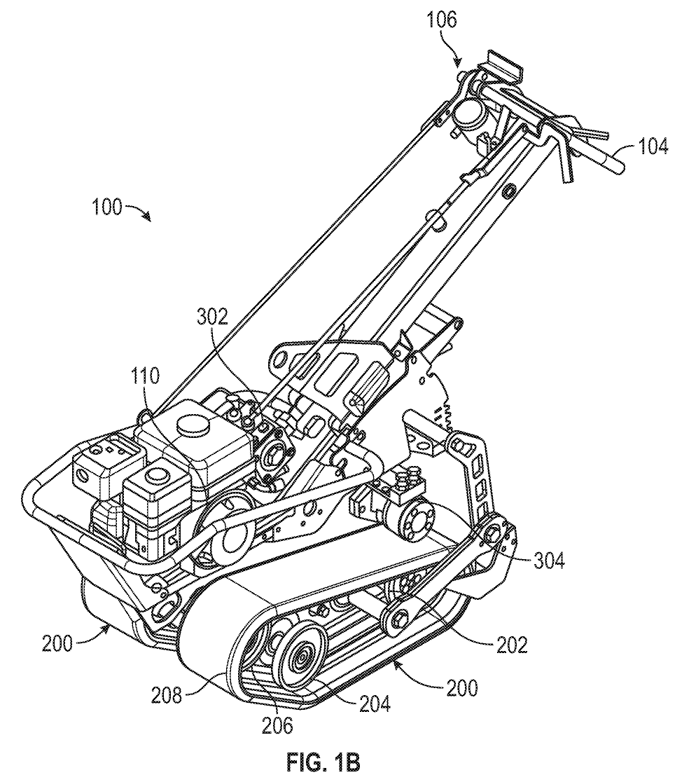

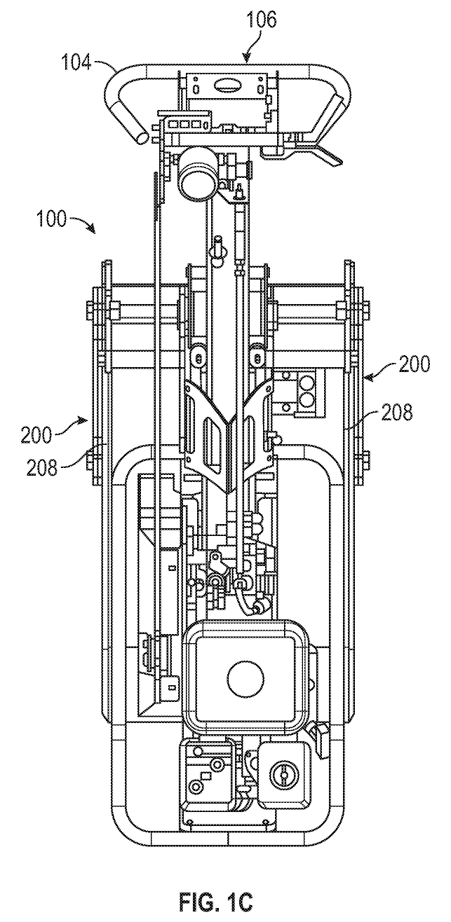

FIGS. 1A-5 illustrate an exemplary walk-behind apparatus configured as a sod cutter 100 employing a pair of continuous track systems 200 (also referred to as a “drive assembly”) for support and propulsion. Each continuous track system 200 is configured to be mounted to the body of the sod cutter 100. For ease of discussion, the following description relates to a single continuous track system 200. It is understood that the arrangement, orientation, and/or configuration of the continuous track system 200 described herein can be adapted for various applications.

FIGS. 1A-1C depict various aspects of the sod cutter 100 which comprises two continuous track systems 200 and a hydraulic drive system 300 which will be described in detail below. As depicted, the sod cutter 100 comprises a carriage assembly 102, a handle 104, a control interface 106, a sod cutting blade 108, and an engine 110. The carriage assembly 102 may also be referred to as main body and may serve as a structure for the other components to be attached. The handle 104 may be sized and positioned to be pushed by an operator. In some examples, the control interface 106 may be coupled to the handle 104 and may comprise one or more control elements such as knobs, buttons, switches, dials, etc. The control elements may control certain aspects of the operation of the walk-behind apparatus. For example, the sod cutter 100 may have a control element which controls the deployment of the sod cutting blade 108 as well as the depth of the cut. In some examples, the control elements may control aspects of operation of the track assemblies 200 and/or the hydraulic drive system 300.

As shown in FIGS. 1A-1C, the track assembly 200 may comprise one or more drive wheels and/or idler wheels, a continuous track, and a tensioning system. The one or more drive wheels and/or idler wheels are rotatable relative to the carriage assembly by one or more axels. In the illustrated example, the track assembly 200 comprises a drive wheel 202 (also referred to as a “drive sprocket”), a fixed idler wheel 204, and a pivotable idler wheel 206.

A track drive motor or hydraulic motor 304 may be hydraulically coupled to a hydrostatic pump 302 and mechanically coupled to the drive wheel 202. The hydraulic motor 304 can be configured to propel the continuous track 208 and move the walk-behind apparatus in a first, forward direction (e.g., to the left in FIG. 1A) and/or a second, reverse direction (e.g., to the right in FIG. 1A). Although described as a hydraulic motor coupled to a hydrostatic pump, the track drive motor can also be an electric motor, an internal combustion engine, or any other source of motive power or prime mover. In some examples, the hydraulic motor can be coupled to the body of the walk-behind apparatus directly and/or to the carriage frame and can be either in a fixed position or provided suspension.

In some examples, the track drive motor is coupled to the drive wheel 202 by a chain drive or a belt. The continuous track 208 may be disposed around the drive wheel 202, the fixed idler wheel 204, and the pivotable idler wheel 206 and be driven by the drive wheel 202. Any or all of the fixed idler wheel 204, the pivotable idler wheel 206, and/or the drive wheel 202 can comprise one wheel or a pair of wheels coupled to an axle.

The continuous track 208 may be situated around the drive wheel 202, the idler wheel 204 and the pivotable idler wheel 206 such that rotational motion of the drive wheel 202 causes rotation of the continuous track 208. In some examples, the continuous track 208 can be made of soft material, such as a synthetic rubber, or a rigid material such as reinforced steel wires and/or plates, and/or a combination of soft and rigid materials. The continuous track can also have a chain link or belt configuration with a plurality of links or pegs.

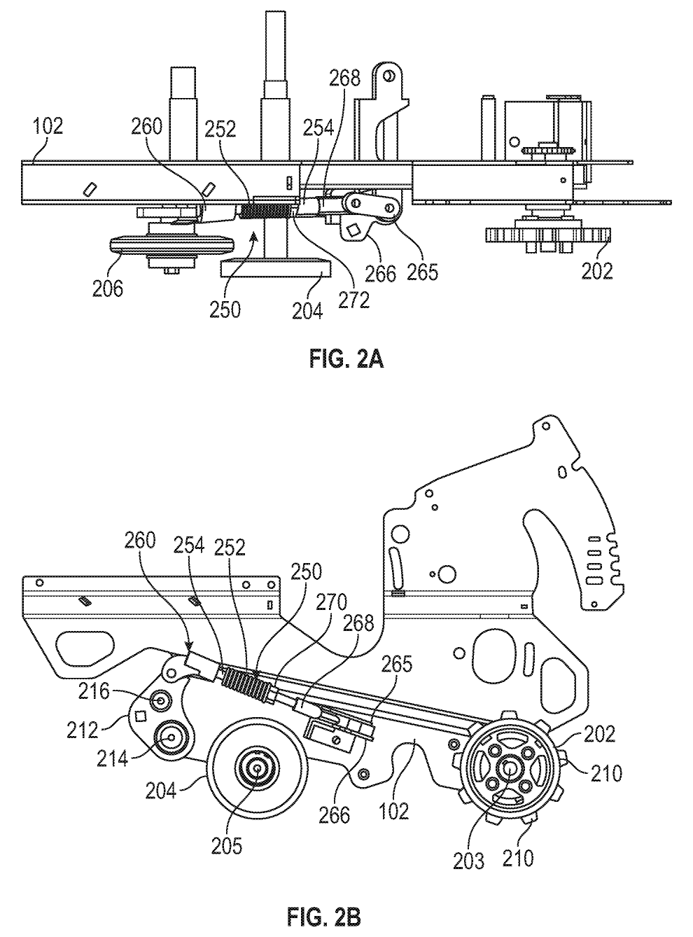

FIGS. 2A-2B depict portions of track assembly 200 of the sod cutter of FIG. 1 with the continuous track removed. The drive wheel 202 may comprise a plurality of teeth 210 which can be sized and shaped to fit within corresponding slots on the continuous track 208 as described above. For example, the teeth of the drive wheel 202 engage with the holes or spaces between the plurality of links or pegs of the continuous track such that the track is propelled by rotation of the drive wheel 202. The drive wheel may be rotatably coupled to the carriage assembly 102 at a drive wheel axle 203.

The track assembly 200 can also include one or more idler wheels to guide the track 208 around the carriage and/or further tension the continuous track 208. One or more of the idler wheels can be disposed along a bottom length of the track assembly 200 and serve as “road wheels.” In some examples, the road wheels can be configured to help support the weight of the walk-behind apparatus such that the continuous track 208 engages and is able to traverse the terrain navigated by the sod cutter 100. The depicted example includes a single idler wheel 204 which is rotatably coupled to the carriage assembly 102 at an idler wheel axle 205. Though the depicted example includes a single idler wheel, any number of idler wheels, road wheels, return rollers and/or bogies may be included in the track assembly.

Tension may be applied to the continuous track 208 by the pivotable idler wheel 206. The position of the pivotable idler wheel 206, and thus the amount of tension applied to the continuous track 208, may be determined by the tensioning system 250. In some examples, the pivotable idler wheel 206 may be rotatably coupled to a first end portion of an arm 212 at a pivotable idler wheel axle 216. The other end portion of the arm 212 may be pivotably coupled to the carriage assembly 102 at a fixed pivot point 214 such that the pivotable idler wheel 206 may pivot about the fixed pivot point 214 which is offset from the rotation of the pivotable idler wheel 206 about the pivotable idler wheel axle 216.

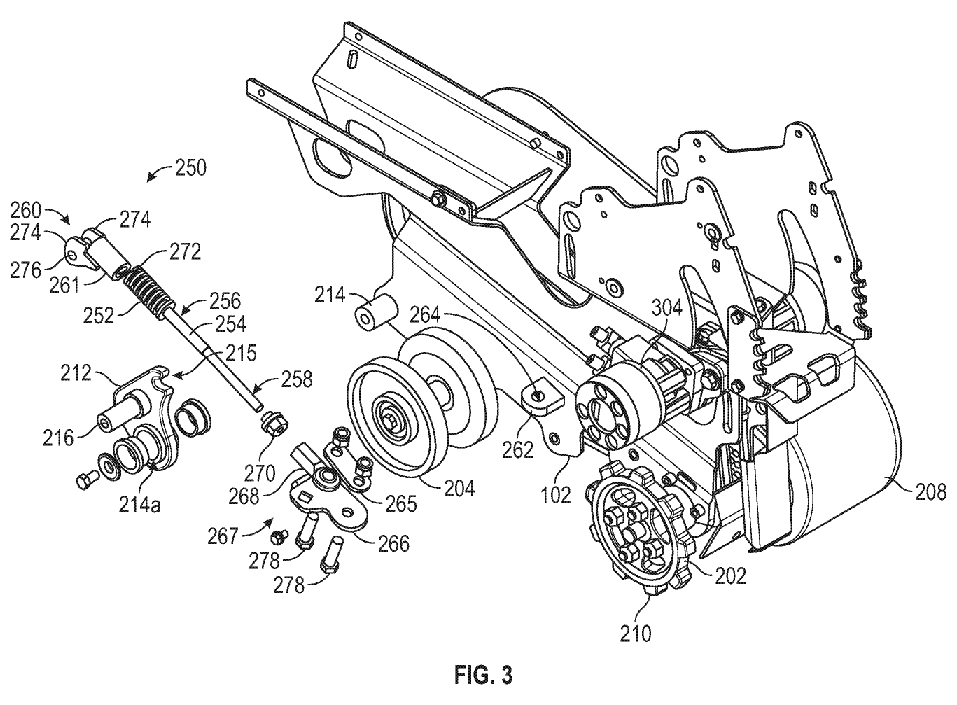

For ease of illustration and discussion, the tensioning system 250 is shown removed and displayed in an exploded state in FIG. 3. As shown in FIG. 3, the tensioning system 250 includes a biasing member configured as a coil spring 252, a tensioner rod 254, an adjustment member 270 (also referred to as a “tension adjustment mechanism”), and a tensioner fork 260. The tensioner rod 254 can comprise a first end portion 256 and a second end portion 258. The tensioning system 250 can be coupled to the carriage frame 102 via a lever member 267.

As depicted, the first end portion 256 of the tensioner rod 254 can be slidably coupled to the tensioner fork 260 which is configured to interface with the arm 212 to pivot the pivotable idler wheel 206 about the fixed pivot point 214. In some examples, the tensioner fork 260 may comprise a tube portion 261 with a through hole 272 which is configured to axially overlap and slide relative to the first end portion 256 of the tensioner rod 254. In other words, the first end portion 256 of the tensioner can extend through the through hole 272 of the tube portion. The tensioner fork 260 may also have two side plates 274 which extend from the tube portion 261 and a rod 276 which extends perpendicular to and between the two side plates 274.

As depicted, the arm 212 may comprise a cutout or slot 215 configured to receive a portion of the tensioner fork 260, for example the rod 276. In some examples, the first end portion 256 of the tensioner rod 254 may be configured to interact with the arm 212 in another way, such as a ball and socket, a flexible linkage, etc. In some examples, the cutout or slot may be disposed on the first end portion of the tensioner rod and the tensioner fork portion may be disposed on the arm.

The second end portion 258 of the tensioner rod 254 can be pivotably coupled to the lever member 267. As depicted the lever member 267 can comprise a first plate 265 and a second plate 266 (also referred to as a “cam plate”). The first plate 265 and the second plate 266 can each have two holes through them sized and shaped to receive bolts 278. In some examples, the second end portion 258 of the tensioner rod 254 can be inserted into a heim joint 268 which can be coupled between the first plate 265 and the second plate 266. One of the bolts 278 can extend through a first hole in the first plate 265, the heim joint 268, and a first hole in the second plate 266. The carriage assembly 102 may comprise a connection point for receiving the other end of the lever member 267, for example a protrusion 262 (also referred to as a “mounting flange”) with a through hole 264. One of the bolts 278 can extend through a second hole of the first plate 265, the through hole 264, and a second hole of the second plate 266. The assembly can be secured with nuts threaded onto the bolts 278. In other examples, the lever member can comprise a single plate or more than two plates.

The coil spring 252 may be disposed around the tensioning rod 254 and may extend from the tube 261 of the tensioner fork 260 to the adjustment member 270. The adjustment member 270 can be moved relative to the second end portion 258 of the tensioner rod 254 to compress or relax the coil spring and thereby apply more or less tension to the continuous track 208. For example adjusting the adjustment member can result in a change in compression of the biasing member, such as the biasing member transitioning from a first compression to a second compression (e.g., from a first, more compressed state to a second, less compressed state or vice versa).

In some examples, the second end portion 258 of the tensioner rod 254 can have external threads and the adjustment member 270 may be disposed around the second end portion 258. In some examples, the adjustment member 270 can comprise a tensioner rod nut which can have internal threads sized and shaped to interface with the external threads of the second end portion 258. Although the adjustment member in the illustrated example is described a nut with internal threads, other mechanical, electromechanical, and/or pneumatic devices configured to adjust the tension in the biasing member can be used according to the principles described herein.

The coil spring 252 may compress or expand as the track assembly 200 is operated and may provide a force which keeps the continuous track 208 at a selected tension. The spring 252 can be used to maintain tension in a continuous track 208 when the walk-behind apparatus moves in a first direction (e.g., forward). Although the biasing member in the illustrated example is described as a coil spring it is understood that other mechanical, electromechanical, and/or pneumatic devices configured to apply force between objects or surfaces can be used according to the principles described herein.

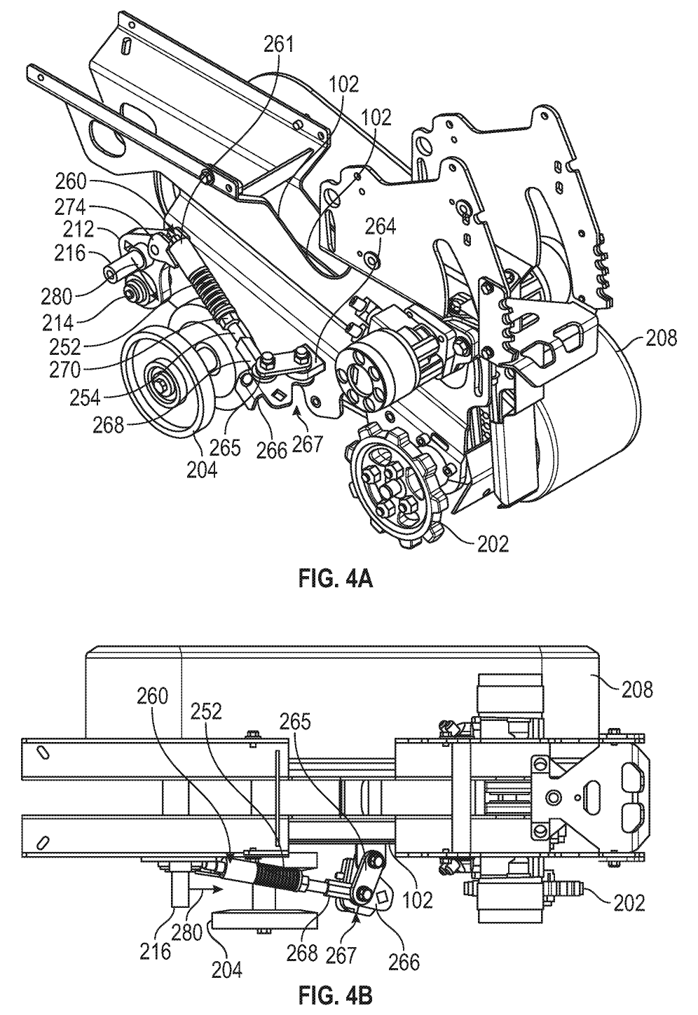

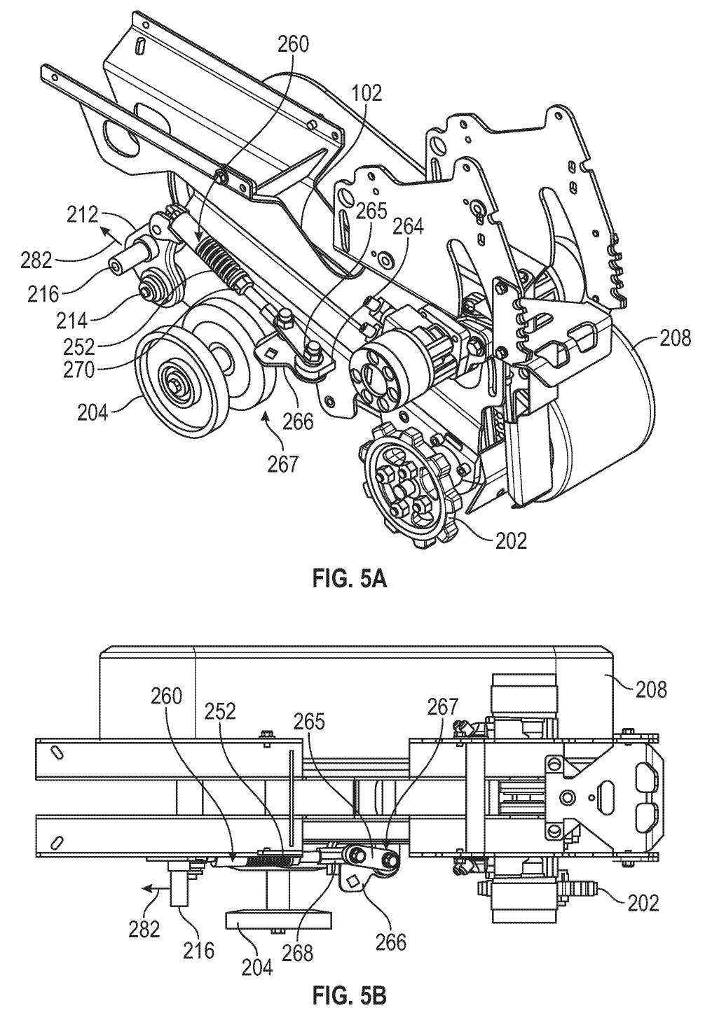

The example illustrated in FIGS. 4A-5B depict portions of a drive assembly of the sod cutter 100 with the continuous track 208 and the pivotable idler wheel 206 removed. FIGS. 4A-4B depict the tensioning system in a position corresponding to reduced tension in the continuous track 208 (FIG. 1A). With the lever member 267 pivoted outward away from the carriage assembly 102, the arm 212 and therefore the pivotable idler wheel axle 216, move in a first direction as depicted by arrow 280. In other words, the arm 212 rotates about the fixed pivot point 214 which causes the axle 216 to move rearward. Although not depicted in FIG. 4A-4B, the pivotable wheel 204 moves in the first direction 280 with the motion of the pivotable idler wheel axle 216 and therefore reduces tension on the continuous track 208. In other words, when the lever member 267 pivots outward away from the carriage assembly 102 it results in movement of the pivotable idler wheel 204 in the first direction 280 rearward relative to the carriage assembly 102 and reduces the tension in the continuous track 208. In some examples, this can be used to relieve tension on the continuous track 208 and allow removal of the continuous track 208.

FIGS. 5A-5B depict the tensioning system in a position corresponding to increased tension in the continuous track, such as an operational state. With the lever member 267 pivoted inward towards the carriage assembly 102, the arm 212 and therefore the pivotable idler wheel axle 216, move in a second direction depicted by arrow 282. Although not depicted in FIG. 4A-4B, the pivotable wheel 204 moves in the second direction 282 with the pivotable idler wheel axle 216 and therefore increases tension on the continuous track 208. In other words, when the lever member 267 pivots inward toward the carriage assembly 102 it results in the arm 212 rotating about the fixed pivot point 214 which causes movement of the pivotable idler wheel 204 in the second direction 282 (e.g., forward) relative to the carriage assembly 102 and increases tension in the continuous track 208. In some examples, this can be used to increase tension on the continuous track 208 to operational tension after the continuous track is installed.

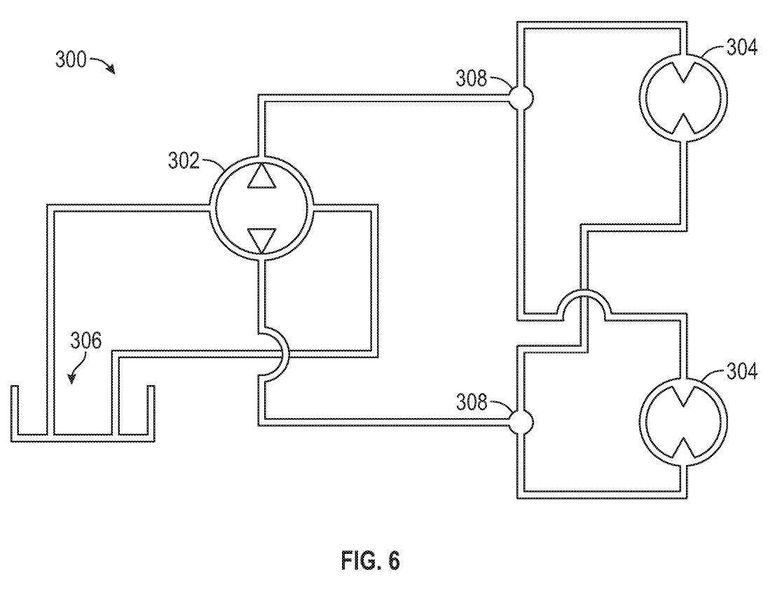

FIG. 6 depicts a schematic of a hydraulic system 300 of the sod cutter of FIG. 1. The hydraulic system 300 may comprise one or more hydrostatic pumps and one or more hydraulic motors. In the depicted example the hydraulic system 300 comprises one hydrostatic pump 302 and two hydraulic motors 304. In some examples, additional hydraulic fluid can be stored in a reservoir 306 hydraulically coupled to the hydrostatic pump 302. Each hydraulic motor can be mechanically coupled to a drive wheel 202 as discussed above and used to propel a track system 200. The hydrostatic pump 302 can be connected to each hydraulic motor 304 using tee splitters 308. In other words, the hydrostatic pump 302 can be hydraulically connected to the hydraulic motors 304 without a hydraulic differential. This allows pressure to be directed to the side with less pressure automatically as the walk-behind apparatus is turned. This also has the advantage of not requiring the additional complexity of a hydraulic differential or valves.

In some examples, a hydraulic differential lock valve may be used in the hydraulic system 300 between the hydrostatic pump 302 and two hydraulic motors 304. The hydraulic differential lock valve can be used to operate the hydraulic motors 304 at a constant flow rate ratio. For example, the lock valve can be used to operate the hydraulic motors at the same flow rate as one another, and thus at constant speed. The use of a hydraulic differential lock valve can have the advantage of helping to prevent the track system 200 from losing traction and slipping in poor conditions.

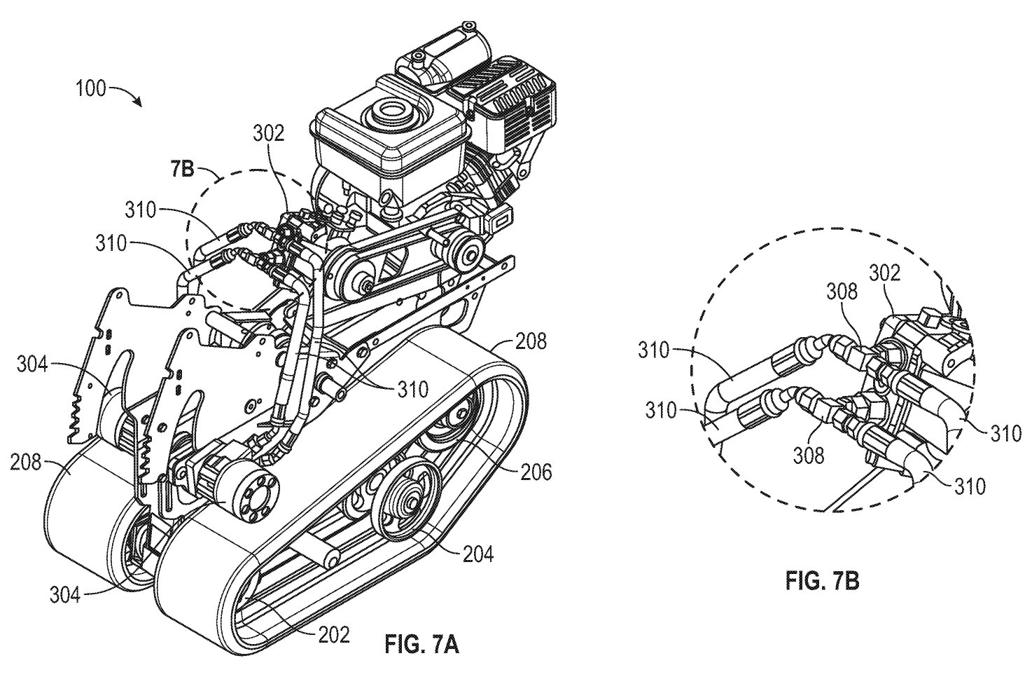

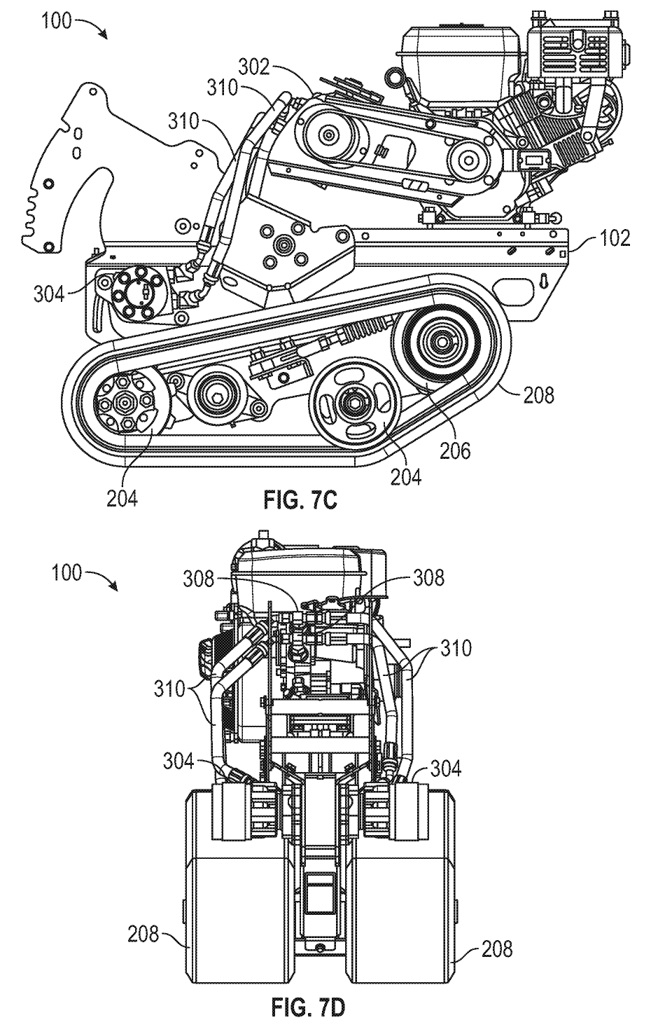

FIGS. 7A-7D illustrate the sod cutter 100 with the hydraulic hoses 310 installed according to the hydraulic schematic shown in FIG. 6. In this view, the hydraulic system 300 is fully integrated with the sod cutter frame and track assemblies 200. The hydraulic hoses 310 extend from the hydrostatic pump 302 to the respective hydraulic motors 304 that drive the continuous tracks 208. The routing of the lines is arranged to minimize interference with other components while maintaining accessibility for service. This figure provides an overall perspective of how the hydraulic system is physically implemented on the sod cutter.

FIG. 7B provides a detailed, zoomed-in view of the tee splitters 308 and their connection to the hydraulic hoses 310. The tee splitters 308 can allow the hydrostatic pump 302 to distribute hydraulic fluid to both hydraulic motors 304 without the need for a hydraulic differential. This configuration allows pressure balancing between the two sides during operation, simplifying the system while maintaining effective steering control. The enlarged depiction highlights the orientation of the tee splitters 308 and the secure coupling of the hydraulic hoses 310, ensuring leak-free operation under varying pressure conditions.

FIGS. 7C-7D show an alternate angles of the sod cutter 100 with the hydraulic hoses 310 installed, emphasizing the integration of the hydraulic system with the carriage assembly 102 and track assemblies 200. The hydraulic hoses 310 can be routed and secured with clamps to prevent abrasion and vibration during use. The arrangement can help ensure that the hydraulic system remains protected while allowing the sod cutter to maintain its compact profile and maneuverability. Together, FIGS. 7A–7D illustrate an implementation of the hydraulic schematic in FIG. 6 on the sod cutter 100, according to one example.

The technology described above can be applicable to any vehicle having a continuous track propulsion system, including utility vehicles such as walk-behind vehicles and riding vehicles (e.g., sod cutters, trenchers, chippers, mulchers, shredders, lawn mowers, augers/post hole diggers, snowmobiles, etc.), construction vehicles (e.g., bulldozers, excavators, skid-steer loaders, etc.), military vehicles, or the like.

### General Considerations

For purposes of this description, certain aspects, advantages, and novel features of the examples of this disclosure are described herein. The disclosed methods, apparatus, and systems should not be construed as being limiting in any way. Instead, the present disclosure is directed toward all novel and nonobvious features and aspects of the various disclosed examples, alone and in various combinations and sub-combinations with one another. The methods, apparatus, and systems are not limited to any specific aspect or feature or combination thereof, nor do the disclosed examples require that any one or more specific advantages be present or problems be solved.

Although the operations of some of the disclosed examples are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

As used in this disclosure and in the claims, the singular forms “a,” “an,” and “the” include the plural forms unless the context clearly dictates otherwise. Additionally, the term “includes” means “comprises.” Further, the terms “coupled” and “associated” generally mean electrically, electromagnetically, and/or physically (e.g., mechanically or chemically) coupled or linked and does not exclude the presence of intermediate elements between the coupled or associated items absent specific contrary language.

In some examples, values, procedures, or apparatus may be referred to as “lowest,” “best,” “minimum,” or the like. It will be appreciated that such descriptions are intended to indicate that a selection among many alternatives can be made, and such selections need not be better, smaller, or otherwise preferable to other selections.

In the description, certain terms may be used such as "up," "down," "upper," "lower," "horizontal," "vertical," "left," "right," and the like. These terms are used, where applicable, to provide some clarity of description when dealing with relative relationships. But, these terms are not intended to imply absolute relationships, positions, and/or orientations. For example, with respect to an object, an "upper" surface can become a "lower" surface simply by turning the object over. Nevertheless, it is still the same object.

Unless otherwise indicated, all numbers expressing quantities of components, forces, moments, molecular weights, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under test conditions/methods familiar to those of ordinary skill in the art. When directly and explicitly distinguishing examples from discussed prior art, the example numbers are not approximates unless the word “about” is recited. Furthermore, not all alternatives recited herein are equivalents.

Although there are alternatives for various components, parameters, operating conditions, etc., set forth herein, that does not mean that those alternatives are necessarily equivalent and/or perform equally well. Nor does it mean that the alternatives are listed in a preferred order unless stated otherwise.

In view of the many possible ways in which the principles of the disclosure may be applied, it should be recognized that the illustrated configurations depict examples of the disclosed technology and should not be taken as limiting the scope of the disclosure nor the claims. Rather, the scope of the claimed subject matter is defined by the following claims and their equivalents.

We claim:

1. A walk-behind apparatus comprising:
a carriage assembly;
a hydrostatic pump; and
two drive assemblies, each drive assembly comprising:
a hydraulic motor, hydraulicly coupled to the hydrostatic pump;
a pivotable idler wheel pivotably coupled to the carriage assembly at a pivot point, wherein the pivot point is fixed relative to the carriage assembly;
a fixed idler wheel rotatably coupled to the carriage assembly;
a drive wheel rotatably coupled to the carriage assembly;
a continuous track extending around the pivotable idler wheel, the fixed idler wheel, and the drive wheel; and
a tensioning system comprising:
a tensioner rod with a first end portion and a second end portion, wherein the first end portion is coupled to the pivotable idler wheel; and
a lever member pivotably coupled to the carriage assembly and to the second end portion of the tensioner rod, wherein pivoting the lever member outward away from the carriage assembly results in the pivotable idler wheel moving in a first direction relative to the carriage assembly and reducing tension in the continuous track, and wherein pivoting the lever member inward toward the carriage assembly results in the pivotable idler wheel moving in a second direction relative to the carriage assembly and increases tension in the continuous track.

2. The walk-behind apparatus of claim 1, further comprising a biasing member disposed around the tensioner rod, wherein the biasing member is sized and shaped to maintain tension in the continuous track while the lever member is pivoted inward toward the carriage assembly.

3. The walk-behind apparatus of claim 2, further comprising an adjustment member disposed on the tensioner rod, wherein adjusting a position of the adjustment member results in a change in compression of the biasing member.

4. The walk-behind apparatus of claim 1, wherein the lever member comprises a first plate and a second plate.

5. The walk-behind apparatus of claim 1, wherein the drive wheel is driven by the hydraulic motor.

6. The walk-behind apparatus of claim 1, wherein a heim joint couples the lever member to the second end portion of the tensioner rod.

7. A walk-behind apparatus comprising:
a carriage assembly; and
one or more drive assemblies, each drive assembly comprising:
a pivotable idler wheel pivotably coupled to the carriage assembly at a pivot point wherein the pivot point is fixed relative to the carriage assembly;
a drive wheel;
a continuous track extending around the pivotable idler wheel and the drive wheel; and
a tensioning system comprising:
a tensioner rod with a first end portion and a second end portion, wherein the second end portion is coupled to the pivotable idler wheel; and
a lever member pivotably coupled to the carriage assembly and pivotably coupled to the first end portion of the tensioner rod, wherein the lever member pivots outward away from the carriage assembly to a first state and inward toward the carriage assembly to a second state to move the pivotable idler wheel from a first position to a second position, and wherein there is more tension on the continuous track in the second state than in the first state.

8. The walk-behind apparatus of claim 7, each drive assembly further comprising a fixed idler wheel rotatably coupled to the carriage assembly, wherein the continuous track extends around the fixed idler wheel.

9. The walk-behind apparatus of claim 7, further comprising a biasing member disposed around the tensioner rod, wherein the biasing member is sized and shaped to maintain tension in the continuous track while the lever member is in the second state.

10. The walk-behind apparatus of claim 9, wherein the biasing member is a coil spring.

11. The walk-behind apparatus of claim 9, further comprising an adjustment member, wherein adjusting the adjustment member results in the biasing member transitioning from a first compression to a second compression.

12. The walk-behind apparatus of claim 7, wherein the lever member comprises a first plate and a second plate.

13. The walk-behind apparatus of claim 7, wherein a heim joint couples the lever member to the first end portion of the tensioner rod.

14. The walk-behind apparatus of claim 7, wherein the drive wheel is driven by a hydraulic motor.

15. The walk-behind apparatus of claim 14, wherein the hydraulic motor is hydraulically coupled to a hydrostatic pump.

16. The walk-behind apparatus of claim 15, wherein the hydraulic motor is hydraulically coupled to the hydrostatic pump without a hydraulic differential.

17. A method of operating the walk-behind apparatus of claim 7, the method comprising:
tensioning the continuous track by moving the lever member from the first state to the second state.

18. The method of claim 17, wherein the apparatus further comprises a biasing member disposed around the tensioner rod and an adjustment member, and wherein the method further comprises adjusting a position of the adjustment member to change a compression in the biasing member.

19. A track drive assembly comprising:
a pivotable idler wheel pivotable relative to a fixed pivot point;
a drive wheel driven by a hydraulic motor;
a continuous track extending around the pivotable idler wheel and the drive wheel; and
a tensioning system comprising:
a tensioner rod with a first end portion and a second end portion, wherein the second end portion is coupled to the pivotable idler wheel; and
a lever member pivotably coupled between a carriage assembly and the first end portion of the tensioner rod, wherein the lever member pivots outward away from the carriage assembly to a first state and inward toward the carriage assembly to a second state, and wherein there is more tension on the continuous track in the second state than in the first state.

20. The track drive assembly of claim 19, further comprising a fixed idler wheel rotatably coupled to the carriage assembly, wherein the continuous track extends around the fixed idler wheel.
